(19) United States
(12) Patent Application Publication
(10) Pub. No.: US 2025/0029823 A1
(43) Pub. Date: Jan. 23, 2025

(54) Electron-Based Fragmentation Method

(71) Applicant: DH Technologies Development Pte. Ltd., Singapore (SG)

(72) Inventors: John Lawrence CAMPBELL, Newmarket (CA); Bill LOYD, Sugar Land, TX (US); Pavel RYUMIN, Toronto (CA)

(21) Appl. No.: 18/569,781

(22) PCT Filed: Jun. 24, 2022
(86) PCT No.: PCT/IB2022/055906

§ 371 Date: Dec. 13, 2023

Related U.S. Application Data
(60) Provisional application No. 63/215,847, filed on Jun. 28, 2021.

(51) Int. Cl. H01J 49/00; H01J 49/42

(52) U.S. Cl. CPC H01J 49/0054; H01J 49/0031; H01J 49/0036; H01J 49/4225

(57) ABSTRACT

The present disclosure provides methods and systems for performing mass spectrometry in which at least two batches of precursor ions generated via ionization of at least two different portions of a sample are exposed to electron beams at different energies to cause fragmentation of at least a portion of the precursor ions. In some embodiments, the electron energies can be selected such at one of the electron energies, EIEIO fragmentation can occur while at the other electron energy, EIEO fragmentation channel is not available. The mass spectra corresponding to the two energies can then be utilized to generate a resultant mass spectrum in which mass peaks corresponding to ion fragments generated by EIEIO dissociation are more readily identifiable.

### BACKGROUND

The present teachings are related to methods and systems for performing mass spectrometry and mass spectrometers that allow performance of such methods, and more particularly to mass spectrometric methods in which fragmentation of precursor ions is accomplished via electron impact excitation, such as Electron Impact Excitation of Ions from Organics (EIEIO).

Mass spectrometry (MS) is an analytical technique for determining the structure of test chemical substances with both qualitative and quantitative applications. MS can be useful for identifying unknown compounds, determining the composition of atomic elements in a molecule, determining the structure of a compound by observing its fragmentation, and quantifying the amount of a particular chemical compound in a mixed sample. Mass spectrometers detect chemical entities as ions such that a conversion of the analytes to charged ions must occur during the sampling process.

In some mass spectrometric methods, precursor ions are fragmented to generate a plurality of product ions, which are in turn mass analyzed to provide additional information regarding the precursor ions. By way of example, in multiple reaction monitoring mass spectrometry (MRM-MS), multiple fragment ion products are generated via fragmentation of a precursor ion and the product ions are monitored to obtain structural information regarding the precursor ion.

One method of ion fragmentation that can be employed is known as Electron Impact Excitation of Ions from Organics (EIEIO) in which precursor ions trapped within an ion trap, e.g., a branched radiofrequency (RF) ion trap, can be fragmented via exposure to an electron beam. One shortcoming of such an approach is the unintended fragmentation of certain labile ions via collision-induced dissociation (CID), which can render the analysis of the resultant mass spectrum difficult. In addition, at optimal electron energies for EIEIO fragmentation, many background neutral molecules present in the trap can also undergo ionization and hence add noise to the resultant mass spectrum.

Accordingly, there is a need for enhanced methods and systems for performing mass spectrometry in which ion impact dissociation is employed for ion fragmentation.

### SUMMARY

In one aspect, a method of performing mass spectrometry is disclosed, which comprises ionizing a first portion of a sample to generate a plurality of precursor ions, introducing at least a portion of the precursor ions into an ion trap and exposing the trapped ions (or at least a portion thereof) to an electron beam having a first energy so as to cause fragmentation of at least a portion of the trapped ions. Subsequently, at least a portion of the ions present in the ion trap is released and at least a portion of the released ions is detected and a mass spectrum thereof is generated.

Another portion of the sample is then ionized to generate another batch of precursor ions, and these precursor ions (or at least a portion thereof) are introduced into the ion trap and exposed to an electron beam having a second energy that is different from the first energy to cause dissociation of at least a portion of the trapped ions. The trapped ions, or at least a portion thereof, are released from the ion trap and at least a portion of the released ions is detected and a mass spectrum thereof is generated. The first and the second energy of the electron beam (i.e., the kinetic energy of the electrons in the beam) are selected such that fragmentation of the precursor ions via Electron Impact Excitation of Ions from Organics (EIEIO is more probable at one energy than at the other energy. For example, in some embodiments, the EIEIO fragmentation channel is not available at one of the energies and the precursor ions may undergo fragmentation via other mechanisms, such as collision induced dissociation (CID) and CID-like fragmentation mechanisms.

At the other energy, the EIEIO fragmentation channel as well as other fragmentation channels (such as CID and CID-like channels) are also available. The mass spectra acquired at the two energies can be subtracted from one another to generate a resultant mass spectrum in which the mass peaks associated with the fragment ions generated via EIEIO fragmentation are more readily identifiable. The generation of the mass spectra at the two energies can be performed immediately after the detection of the ions, or after the data acquisition at the two energies is completed.

The mass spectrum obtained at the electron energy at which EIEIO is less probable (or preferably inhibited) can be subtracted from the mass spectrum obtained at the other energy so as to reduce (and preferably eliminate) the mass peaks that correspond to ion fragments generated via other mechanisms (such as CID and CID-like mechanisms) as well as those corresponding to any precursor and background ions, thereby providing a resultant mass spectrum that can be more readily analyzed to identify the mass peaks corresponding to the EIEIO-generated fragment ions.

In some embodiments, the precursor ions can be singly charged. For example, in some embodiments, the precursor ions can be singly charged sodiated or potassiated ions.

In some embodiments, the electron energy at which the fragmentation of the precursor ions can be achieved via EIEIO dissociation can be in a range of about 5 eV to about 20 eV, e.g., in a range of about 5 eV to about 15 eV or in a range of about 5 eV to about 10 eV. In some such embodiments, the electron energy at which EIEIO dissociation is inhibited can be less than about 5 eV or greater than about 30 eV, e.g., in a range of about 30 eV to about 50 eV, e.g., in a range of about 45 eV to about 50 eV.

In a related aspect, a mass spectrometer is disclosed, which comprises a branched RF ion trap comprising two sets of rods arranged in a multipole configuration (e.g., a quadrupole configuration) that are positioned axially relative to one another and are shaped so as to provide a central channel having an inlet for receiving a plurality of precursor ions and an outlet through which ions can exit the ion trap, said ion trap further providing a transverse channel for receiving an electron beam such that the electron beam and the received ions can interact in a region located at an intersection of the axial and the transverse channels so as to cause dissociation of at least a portion of the ions.

A source for generating electrons (such as a heated filament) is located in proximity of at least an inlet of the transverse channel. A gate electrode may be optionally utilized for extracting the electrons from the filament. By way of example, such a gate electrode may be positioned between the electron source (e.g., the filament) and the inlet of the transverse channel.

In some embodiments, a DC voltage source is configured to apply a DC voltage to the electron source (e.g., a filament), and a controller in communication with the DC voltage source can control the DC voltage applied to the electron source (e.g., the filament) so as to adjust an energy of the electron beam that is introduced into the transverse channel of the branched ion trap for interaction with the ions introduced into the trap via its axial channel.

In some embodiments, an electrode (a pole electrode) can be positioned in proximity of each inlet of the transverse channel, including the inlet through which an electron beam is introduced into the transverse channel, where the application a DC voltage to the electrode can generate an electric field for trapping ions within the transverse channel.

In some embodiments, the mass spectrometer can include an ion source for receiving a sample and ionizing the sample so as to generate the plurality of precursor ions. An ion guide can be positioned downstream of the ion source for receiving at least a portion of the precursor ions and focusing the ions into an ion beam. A first mass analyzer can be positioned downstream of the ion guide and upstream of the branched RF ion trap for receiving the ion beam, where the first mass analyzer is configured to select those precursor ions having a target m/z ratio or an m/z ratio within a target range for transmission to the branched RF ion trap. At least a portion of the precursor ions undergoes fragmentation in the branched RF ion trap to generate a plurality of product ions.

A second mass analyzer positioned downstream of the branched RF ion trap can receive at least a portion of the generated product ions and an ion detector positioned downstream of the second mass analyzer can receive at least a portion of the product ions transmitted through the second mass analyzer and generate ion detection signals in response to the detection of those ions.

An analysis module in communication with the ion detector can receive the ion detection signals generated by the ion detector and can process those signals to generate a mass spectrum of the ions detected by the ion detector. The analysis module can be further configured to compare the mass spectrum of a portion of the sample acquired with the electron kinetic energy within a regime in which EIEIO fragmentation can occur with the mass spectrum of another portion of the sample acquired with the electron kinetic energy within another regime in which EIEIO fragmentation is inhibited. As noted above, such a comparison can facilitate the identification of those product ions generated via EIEIO fragmentation.

In some embodiments, the analysis module is configured to perform the comparison of the two spectra via spectrum subtraction so as to generate a resultant spectrum, e.g., one in which the EIEIO-generated mass peaks are more readily identified. Further, in some embodiments, the analysis module can be configured to match the mass peaks in the resultant spectrum with spectra in a standard library so as to identify the molecular species giving rise to the mass peaks.

Further understanding of various aspects of the present teachings can be obtained with reference to the following detailed description in conjunction with the associated drawings, which are described briefly below.

### BRIEF DESCRIPTION OF THE DRAWINGS

FIG. 1 is a flow chart depicting various steps of a method according to an embodiment of the present teachings for performing mass spectrometry,

FIG. 2 is a schematic view of a mass spectrometer according to an embodiment, which is configured to perform a method according to the present teachings,

FIG. 3A illustrates total ion current (TIC) data corresponding to the EIEIO fragmentation of (Etodolac+Na) ion at an m/z ratio of 310,

FIG. 3B shows a mass spectrum of (Etodolac+Na) obtained at an electron kinetic energy of 2 eV, which is too low to allow EIEIO fragmentation,

FIG. 3C shows a mass spectrum of (Etodolac+Na) obtained at an electron kinetic energy of 18 eV at which both EIEIO and CID fragmentation can occur,

FIG. 3D shows a subtracted EIEIO fragmentation spectrum of m/z 310 (etodolac+Na), and,

FIG. 4 illustrates two mass spectra, where the top mass spectrum is a subtracted EIEIO fragmentation spectrum of (Lovastatin+K) ion at an m/z ratio of 443, and the bottom spectrum is the NIST 70-eV EI spectrum of lovastatin, and

FIG. 5 schematically depicts an implementation example of a controller/analysis module, which can be used in the practice of various embodiments of the present teachings.

### DETAILED DESCRIPTION

It will be appreciated that for clarity, the following discussion will explicate various aspects of embodiments of the present disclosure, while omitting certain specific details wherever convenient or appropriate to do so. For example, discussion of like or analogous features in alternative embodiments may be somewhat abbreviated. Well-known ideas or concepts may also for brevity not be discussed in any great detail. One of ordinary skill will recognize that some embodiments of the present disclosure may not require certain of the specifically described details in every implementation, which are set forth herein only to provide a thorough understanding of the embodiments. Similarly it will be apparent that the described embodiments may be susceptible to alteration or variation according to common general knowledge without departing from the scope of the disclosure. The following detailed description of embodiments is not to be regarded as limiting the scope of the applicant's teachings in any manner.

As used herein, the terms “about” and “substantially equal” refer to variations in a numerical quantity that can occur, for example, through measuring or handling procedures in the real world; through inadvertent error in these procedures; through differences in the manufacture, source, or purity of compositions or reagents; and the like. Typically, the terms “about” and “substantially” as used herein means 10% greater or lesser than the value or range of values stated or the complete condition or state. For instance, a concentration value of about 30% or substantially equal to 30% can mean a concentration between 27% and 33%. The terms also refer to variations that would be recognized by one skilled in the art as being equivalent so long as such variations do not encompass known values practiced by the prior art.

As used herein the term “and/or” includes any and all combinations of one or more of the associated listed items and may be abbreviated as “/”. The term “EIEIO” is used herein as an abbreviation for a method of mass spectrometry known as “Electron Impact Excitation of Ions from Organics.”

The present teachings are generally related to methods for performing mass spectrometry as well as mass spectrometers in which such methods can be implemented. More specifically, in one aspect, the present teachings provide methods of performing mass spectrometry in which electron beams at two different distinct electron energies are employed to cause ion fragmentation of a plurality of trapped precursor ions, where at one electron energy ion fragmentation via EIEIO is more probable than at the other electron energy. Preferably, at one electron energy, ion fragmentation via EIEIO is inhibited while at the other electron energy such ion fragmentation can occur. The mass spectra obtained at these two different electron energies can be compared (e.g., subtracted from one another) so as to reduce, and preferably remove, the contributions of ion fragments generated via mechanisms other than EIEIO dissociation, e.g., collision-induced-dissociation (CID) and CID-like fragmentation processes, as well as contributions associated with the unreacted precursor ions and background ions from the resultant mass spectrum, thereby allowing a more facile identification of the ion fragments generated via EIEIO. For example, a mass spectrum obtained at an electron energy of about 18 eV can contain EIEIO generated fragment ions, CID and CID-like fragments of precursor ions, background ions, and unreacted precursor ions while a mass spectrum obtained at an electron energy of about 45-50 eV can contain background ions, CID and CID-like fragments of precursor ions.

In particular, the CID and CID-like fragments and unreacted precursor ions (in particular, singly-charged ions) are present at a high intensity when the electron kinetic energy is about 50 eV because the precursor ions do not fragment via EIEIO dissociation at such high electron energies due to a low cross section of electron capture at these energies. However, the background ions are formed in high abundance at the higher electron kinetic energies since they are sourced from neutral molecules, where the cross section for ionization is still favorable for formation of radical cations. By subtracting the mass spectrum obtained at high energies from that obtained at an energy at which EIEIO fragmentation can occur, a resultant mass spectrum can be obtained in which the mass peaks are essentially the result of the EIEIO dissociation of the precursor ions only, with the mass peaks associated with CID and CID-like generated fragments and the background ions removed. Advantageously, the establishment of such a workflow can allow obtaining the necessary data in one experiment and does not require the acquisition of independent background spectra.

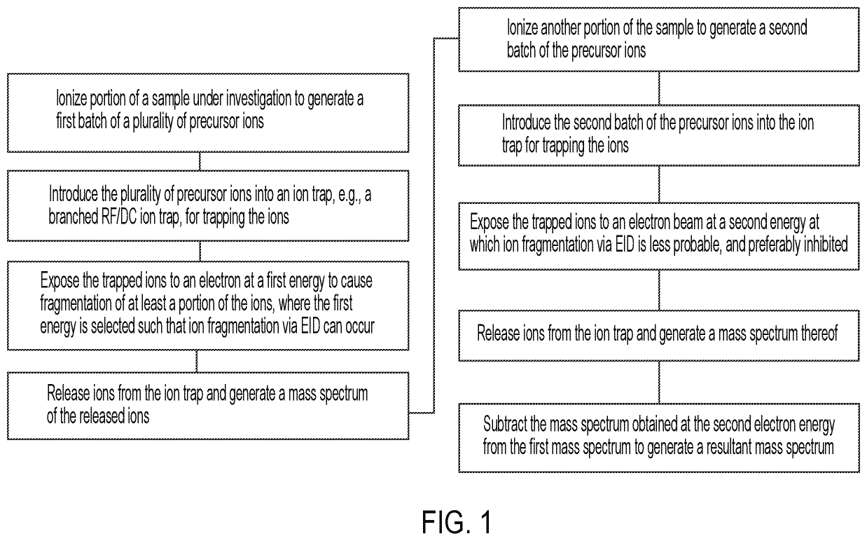

With reference to the flow chart of FIG. 1, in one embodiment of a method according to the present teachings for performing mass spectrometry, a portion of a sample under investigation is ionized to generate a first batch of a plurality of precursor ions, and the precursor ions are introduced into an ion trap that is configured for trapping them. At least a portion of the trapped precursor ions is exposed to an electron beam at a first energy to cause dissociation of at least a portion of the trapped ions to generate a plurality of product ions. Subsequently, the product ions or at least a portion thereof as well as at least some of the precursor ions and/or background ions, if any, are released from the ion trap and a mass spectrum of the released ions is generated.

Subsequently, another portion of the sample is ionized to generate another batch of the precursor ions, and the second batch of the precursor ions is introduced into the ion trap. The second batch of the precursor ions is exposed to an electron beam at a second energy to cause dissociation of at least a portion of the trapped ions. This is followed by releasing the trapped ions (or at least a portion thereof) from the ion trap, detecting the released ions and generating a mass spectrum thereof.

The first and the second ion energies are selected such that the fragmentation of the precursor ions via EIEIO, at one of the first and second energies is more probable than at the other electron energy. For example, one of the mass spectra will include mass peaks associated with EIEIO-generated fragments, as well as mass peaks corresponding to ion fragments generated via other dissociation mechanisms, e.g., CID and CID-like fragmentation processes, as well as mass peaks corresponding to unreacted precursor ions and background ions, while the other mass spectrum will lack mass peaks corresponding to EIEIO-generated ion fragments. A subtraction of the mass spectrum lacking the EIEIO-generated mass peaks from the other spectrum generates a resultant mass spectrum in which EIEIO-generated mass peaks can be more readily identified.

Such identification of the mass peaks corresponding to the EIEIO-generated fragment ions can be achieved by initially identifying mass peaks, if any, corresponding to unreacted precursor ions, background ions and any fragments of the precursor ions generated via CID and/or CID-like fragmentation processes, rather than EIEIO. These identified peaks can then be subtracted from the mass spectrum in which the peaks associated with the EIEIO-generated fragment ions are present so as to generate a mass spectrum of such ions.

In some embodiments, the EIEIO dissociation does not occur at very low or very high electron energies. For example, in some cases, the EIEIO dissociation does not occur at an electron energy less than about 5 eV or greater than about 25 eV. For example, in some embodiments, one of the mass spectra is obtained at an electron energy of 18 eV to ensure that EIEIO fragmentation will occur and the other mass spectrum is obtained at an electron energy in a range of about 45-50 eV at which EIEIO fragmentation will not occur.

In some embodiments, the precursor ions are singly charged. By way of example, such singly-charged precursor ions can include polar ions, such as sodiated and potassiated ions. Some examples of such sodiated and potassiated ions include, without limitation, (Etodolac+Na) and (Lovastatin+K). By way of example, in some embodiments, methods and systems according to the present teachings may be utilized for mass analysis of different classes of lipids. In some embodiments, a target analyte (e.g., a lipid) can be mixed with a solvent (e.g., sodium acetate) to generate sodiated or potassiated ions.

A method for performing mass spectrometry in accordance with the present teachings can be implemented in a variety of mass spectrometers.

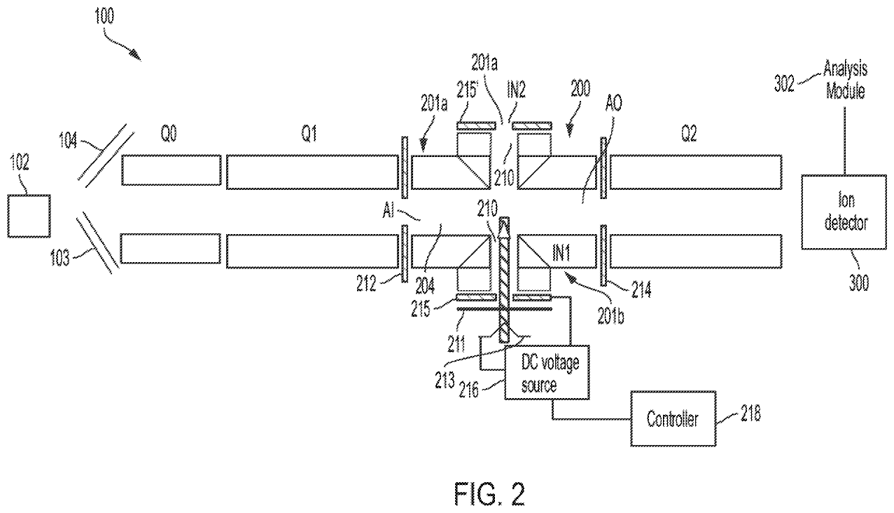

By way of example, FIG. 2 schematically depicts an embodiment of a mass spectrometer 100 that can be utilized to perform mass spectrometry in accordance with the present teachings. The illustrated mass spectrometer 100 includes an ion source 102 that receives a sample from a sample holder (not shown) and ionizes at least a portion of the sample to generate a plurality of ions. The mass spectrometer includes a curtain plate 103 and an orifice plate 104 that is separated from the curtain plate to provide a chamber through which a gas can flow. An ion guide Q0 positioned downstream of the orifice plate receives the ions via transmission through the orifices provided in the curtain plate and the orifice plate.

In this embodiment, the ion guide Q0 includes four rods (two of which are visible in the figure) that are arranged relative to one another in a quadrupole configuration and to which RF and/or DC voltages can be applied to provide radial confinement of the ions and guide the ions to a downstream quadrupole mass filter Q1. The quadrupole mass filter Q1 includes a plurality of rods to which RF and/or DC voltages including a resolving DC voltage can be applied to allow the selection of ions having a desired m/z ratio or m/z ratios within a desired range.

The ions exiting the mass filter Q1 are received by an ion trap 200 that is formed of two quadrupole rod sets 201a and 201b, that are axially positioned relative to one another. Each rod of the quadrupole rod sets 201a and 201b has an L-shaped structure and is positioned relative to the other rods of the quadrupole rod sets so as to provide a central (also herein referred to as an axial) passageway/channel 204 through which ions can pass and a transverse passageway/channel 206 through which electrons generated, e.g., by a heated filament 213, can be transmitted into an ion-electron interaction region located at the intersection of the central and the transverse passageways in which the electrons can interact with the precursor ions to cause fragmentation of at least a portion of the precursor ions.

RF and/or DC voltages can be applied to the rods of the quadrupole rod sets in a manner known in art to provide radial confinement of the ions. Such RF and/or DC voltages can be applied via suitable RF and DC power supplies (not shown in the figure) in a manner known in art. Further, two electrodes 212 and 214 are disposed in proximity of the axial inlet (AI) and outlet (AO) of the ion trap, respectively, where each electrode includes an opening through which ions can pass. The application of DC voltages to these electrodes can facilitate the introduction of the ions into the ion trap and can also provide axial electric potential barriers for axial trapping of the ions within the ion trap.

In this embodiment, the electrons emitted by the heated filament 213 are extracted via an electrode 211, which is maintained at a positive electric potential relative to the heated filament. While in this embodiment the electrode 211 is utilized for extracting electrons from the heated filament 213, in other embodiments such an electrode is not utilized. The emitted electrons are further guided by a pole electrode 215 into the transverse channel 206. In some embodiments, the kinetic energy of the electrons is defined based on a DC potential offset between the electron source (the filament in this embodiment) and the L-shaped electrodes.

The application of DC voltages to the pole electrode 215 as well as another pole electrode 215′ positioned in proximity of another opening IN2 of the transverse channel, which is symmetrically opposed relative to the inlet's IN1 of the transverse channel, can help trap ions within the transverse channel. The trapping of the ions along the axial direction can be facilitated via application of DC voltages to electrodes 212/214. In this embodiment, the L-shaped electrode quadrupole arrangement results in a total of 6 inlets/outlets. Additional electrodes positioned below and above the ECD cell can be installed and prevent ions escaping in vertical direction. Although in this embodiment only one heated filament is employed for generating the electrons, in other embodiments two heated filaments can be used with the other filament positioned in proximity of the opening IN2 of the transverse channel of the ion trap.

In this embodiment, a voltage source 216 can apply a DC voltage to the filament 213. The voltage source 216 can also be coupled to the gate and pole electrodes and/or the electrodes 212/214 for application of DC voltages thereto. Alternatively, one or more additional DC voltage sources may be employed for application of DC voltages to various components, e.g., mass analyzers, of the mass spectrometer.

A controller 218 in communication with the voltage source 216 can control the operation of the voltage source, e.g., for adjusting the level of the DC voltage applied to the electron source 213 for changing the kinetic energy of the electrons generated by the electron source 213. In some embodiments, the adjustment of the kinetic energy of the electrons can be achieved via adjustment of an accelerating voltage applied to an electrode positioned between the electron source and a respective inlet of the transverse channel of the ion trap.

As discussed above, the electrons can interact with the ions and cause fragmentation of at least a portion of the ions. The mode of such fragmentation can depend on the electron's kinetic energy. For example, in a certain energy range, the electron collision dissociation (CID) and/or CID-like dissociation processes are the dominant fragmentation modes with the EIEIO fragmentation mode less probable (or not present) whereas in another energy range both CID, CID-like and EIEIO fragmentation modes may be present. The dissociation of the precursor ions within the ion trap generates a plurality of product ions, which can be analyzed as discussed below.

In particular, in this embodiment, a quadrupole mass analyzer Q2 is positioned downstream of the branched ion trap 200 to receive the ions released from the ion trap. An ion detector 300 disposed downstream of the mass analyzer Q2 can receive ions passing through the mass analyzer Q2 and generate mass detection signals in response to the detection of the ions. An analyzer 302 (herein also referred to as an analysis module) in communication with the detector 300 receives the ion detection signals and processes those signals to generate a mass spectrum of the detected ions.

The controller 218 can adjust a voltage applied to the electron source 213 to change the kinetic energy of the electrons. In particular, the controller 218 can adjust the applied voltage such that a portion of a sample under investigation can be exposed to an electron beam having a kinetic energy at which EIEIO fragmentation can occur, and another portion of the sample is exposed to an electron beam having an energy at which EIEIO fragmentation will not occur.

By way of example, in use, the controller 218 can adjust the voltage applied to the electron source 213 to impart a kinetic energy to the electron beam in an energy regime in which EIEIO fragmentation of the precursor ions will occur, e.g., a kinetic energy in a range of about 5 eV to about 20 eV, e.g., about 10 eV where

A portion of a sample under investigation can be ionized by the ion source 102 to generate a plurality of precursor ions, which are in turn introduced into the mass spectrometer and trapped within the ion trap 200. The exposure of the trapped ions to the electron beam can cause at least a portion of the ions to undergo fragmentation. In addition to EIEIO-generated product ions, at this energy, product ions can also be generated via CID and/or CID-like fragmentation. Further, some of the precursor ions may remain as unreacted ions. In addition, as noted above, in some cases, some of the background neutral molecules can also be ionized.

The product ions as well as unreacted precursor ions and background ions, if any, can then be released from the ion trap, e.g., by changing the DC voltage applied to the inter quad lens electrode 214, to be received by the downstream quadrupole mass analyzer Q2. The ions exiting the mass analyzer Q2 are incident on the downstream ion detector 300, which generates a plurality of ion detection signals in response to the detection of the incident ions. The analysis module 302 can receive the ion detection signals and can generate a mass spectrum of the detected ions.

Subsequently, the controller 218 can adjust the voltage applied to the electron source 213 so as to change the electron beam energy to a value at which EIEIO ion fragmentation will not occur. By way of example, the controller 218 can adjust the applied voltage such that the electron beam energy is less than about 5 eV or greater than about 45 eV. Another portion of the sample under investigation can be ionized to generate another batch of precursor ions, which are received by the ion trap 200 and are trapped therein. The new batch of the trapped precursor ions is then exposed to the electron beam, where the interaction of the ions with the electron beam can cause fragmentation of at least a portion of the precursor ions.

At this electron beam energy, the ion fragmentation cannot occur via EIEIO dissociation. Thus, the product ions can include ion fragments generated by CID and/or CID-like dissociation processes as well as unreacted precursor ions. The ions can then be released from the ion trap and be received by the downstream mass analyzer Q2.

The ions passing through the mass analyzer are detected by the downstream ion detector 300, which generates a plurality of detection signals in response to the detection of the incident ions. The detection signals can be received by an analysis module 302 and processed to generate a mass spectrum of the detected ions.

The analysis module 302 can be configured to compare the mass spectra acquired at two different electron kinetic energies to facilitate the identification of those mass peaks that correspond to EIEIO generated product ions, e.g., via subtraction of the second mass spectrum (i.e., the mass spectrum obtained at an electron energy at which EIEIO fragmentation could not occur) from the first mass spectrum (i.e., the mass spectrum obtained at an electron energy at which EIEO fragmentation could occur) so as to reduce, and preferably eliminate, the mass peaks that correspond to CID-generated (or CID-like generated) ion fragments, unreacted precursor and/or background ions, if any, to reduce the complexity of the resultant mass spectrum for more facile identification of the EIEIO-generated ion fragments.

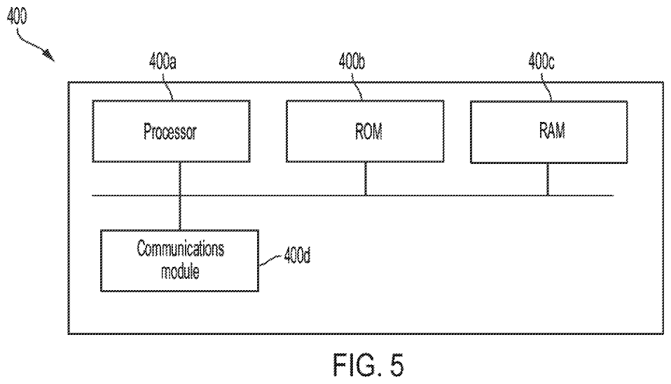

A controller and/or an analysis module employed in various embodiments of the present teachings can be implemented in hardware, firmware and/or software in a manner known in the art as informed by the present teachings. For example, FIG. 5 schematically depicts an example of an implementation of the controller 400, where the controller includes a processor 400a (e.g., a microprocessor), at least one permanent memory module 400b (e.g., ROM), at least one transient memory module (e.g., RAM) 400c, and a communications bus 400d, among other elements generally known in the art. The communications bus 400d allows communication between the processor and various other components of the controller. The controller 400 can further include a communications module 400e that is configured for transmission of control signals, e.g., to the pumps employed to cause the flow of the calibration solution(s) and/or the transport liquid. Instructions for operating the mass spectrometer (including adjustment of the electron kinetic energy) according to various embodiments can be stored in the permanent memory module 400b and can be transferred into the transient memory module 400c during runtime for execution. In some embodiments, an analyzer for use in various embodiments, such as those discussed above, can be similarly implemented. In particular, a set of instructions for processing the acquired mass spectra (e.g., comparison of the mass spectra acquired at different energies) can be stored in the permanent memory and can be transferred to the transient memory during runtime for execution.

The following Examples are provided for further elucidation of various aspects of the present teachings, and are not provided to indicate necessarily the optimal ways of practicing the present teachings or optimal results that may be obtained.

### Examples

Mass spectra of sodiated Etodolac (Etodolac+Na) and potassiated (Lovastatin+K) were obtained using a prototype time-of-flight mass spectrometer equipped with EAD dissociation device at two different electron energies, i.e., 18 eV and ˜45-50 eV.

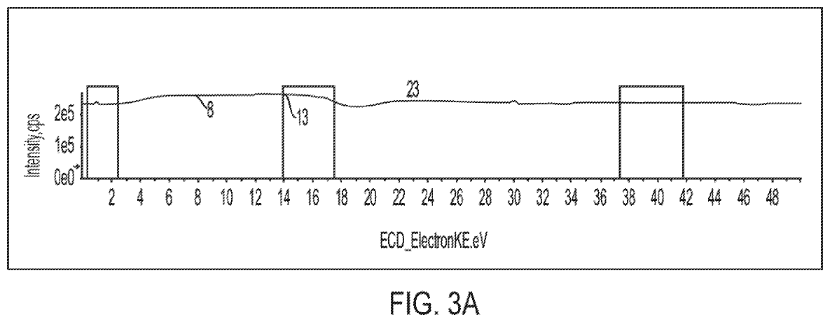

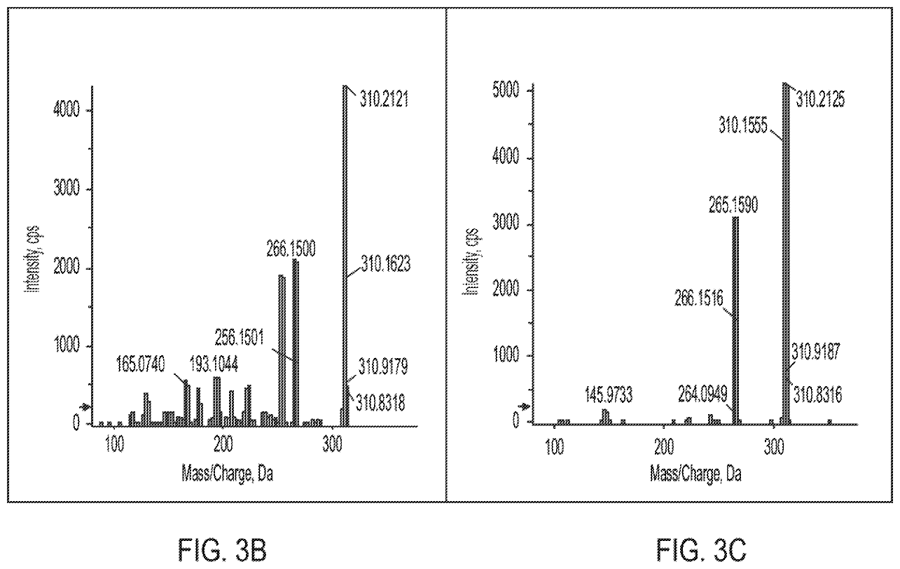

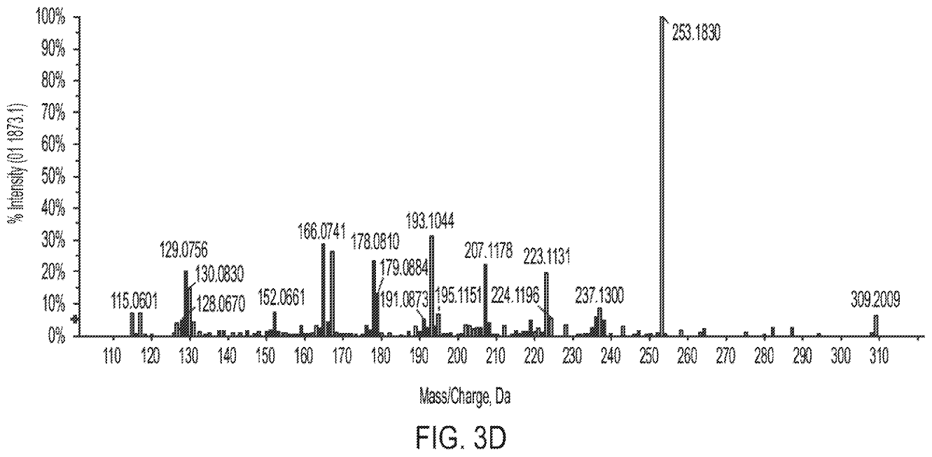

FIG. 3A illustrates total ion current (TIC) data corresponding to the EIEIO fragmentation of (Etodolac+Na) ion at an m/z ratio of 310. In contrast, the mass spectrum shown in FIG. 3B was obtained at an electron kinetic energy of 18 eV at which both EIEIO and CID and/or CID-like fragmentation can occur. Consequently, this mass spectrum exhibits mass peaks corresponding to CID (CID-like) fragments, EIEIO fragments as well as unreacted precursor and background ions. FIG. 3C in turn shows a mass spectrum that was obtained at an electron kinetic energy of 46 eV, which is too high to allow EIEIO fragmentation. Consequently, the mass spectrum depicted in FIG. 3C shows mass peaks corresponding to CID fragment ions, unreacted precursor and background ions. FIG. 3D shows a subtracted EIEIO fragmentation spectrum of m/z 310 (etodolac+Na).

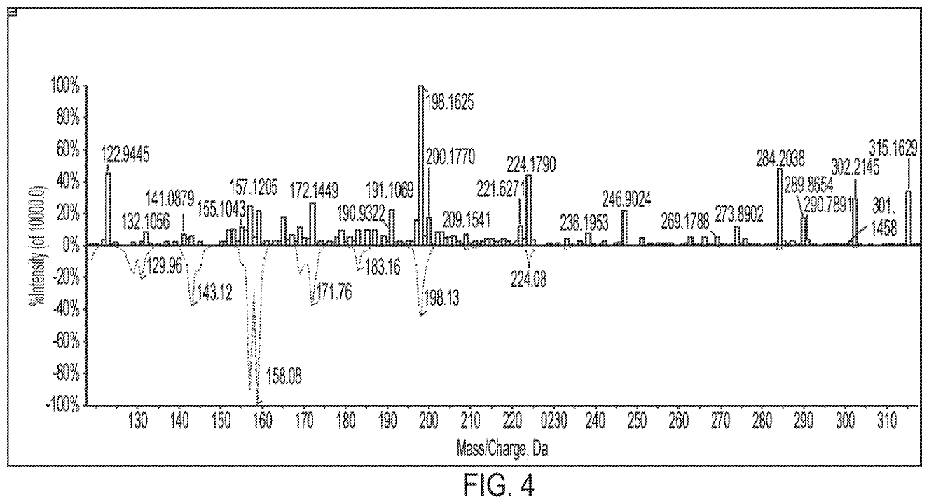

FIG. 4 illustrates two mass spectra, where the top mass spectrum is a subtracted EIEIO fragmentation spectrum of (Lovastatin+K) ion at an m/z ratio of 443, and the bottom spectrum is the NIST 70-eV EI spectrum of lovastatin.

Although some aspects have been described in the context of a system and/or an apparatus, it is clear that these aspects also represent a description of the corresponding method, where a block or device corresponds to a method step or a feature of a method step. Analogously, aspects described in the context of a method step also represent a description of a corresponding block or item or feature of a corresponding apparatus. Some or all of the method steps may be executed by (or using) a hardware apparatus, like for example, a processor, a microprocessor, a programmable computer or an electronic circuit. In some embodiments, some one or more of the most important method steps may be executed by such an apparatus.

Depending on certain implementation requirements, embodiments of the invention can be implemented in hardware and/or in software. The implementation can be performed using a non-transitory storage medium such as a digital storage medium, for example a floppy disc, a DVD, a Blu-Ray, a CD, a ROM, a PROM, and EPROM, an EEPROM or a FLASH memory, having electronically readable control signals stored thereon, which cooperate (or are capable of cooperating) with a programmable computer system such that the respective method is performed. Therefore, the digital storage medium may be computer readable.

Those having ordinary skill in the art will appreciate that various changes can be made to the above embodiments without departing from the scope of the present teachings.

What is claimed is:

1. A method of performing mass spectrometry, comprising:
introducing a first batch of precursor ions generated via ionization of a first portion of a sample into an ion trap configured to trap said ions,
exposing at least a portion of said first batch of trapped precursor ions to an electron beam having a first energy so as to cause dissociation of at least a portion thereof,
subsequently, releasing ions from said ion trap and detecting at least a portion of said released ions and generating a first mass spectrum thereof,
introducing a second batch of precursor ions generated via ionization of a second portion of the sample into the ion trap to trap said second batch of the precursor ions,
exposing said trapped precursor ions to an electron beam at a second energy to cause dissociation of at least a portion thereof, and
subsequently, releasing ions from the ions trap and detecting at least a portion of the released ions and generating a second mass spectrum thereof,
wherein fragmentation of said precursor ions via electron induced dissociation (EID) at one of said first and second energies is more probable than at the other electron energy.

2. The method of claim 1, wherein said EID of the trapped ions can occur only at first energy.

3. The method of claim 2, further comprising subtracting the mass peaks associated with said first mass spectrum from respective mass peaks associated with the second mass spectrum to generate a resultant mass spectrum in which EID-generated fragments are more readily identifiable.

4. The method of claim 1, wherein said precursor ions are singly charged.

5. The method of claim 1, wherein said precursor ions comprise any of singly charged sodiated and potassiated ions.

6. The method of claim 1, wherein said electron energy at which said fragmentation of the precursor ions via EID is more probable is in a range of about 10 eV to about 20 eV.

7. The method of claim 1, further comprising ionizing a sample to generate any of said first and second batch of the precursor ions.

8. The method of claim 1, wherein said electron energy at which said fragmentation of the precursor ions is less probable is in a range of about 30 eV to about 70 eV.

9. The method of claim 1, wherein said ion trap comprises a branched RF ion trap.

10. A mass spectrometer, comprising:
a branched RF ion trap comprising two sets of multipole rods positioned axially relative to one another and shaped so as to provide a central channel having an inlet for receiving a plurality of precursor ions and an outlet through which ions can exit the ion trap, said ion trap further providing a transverse channel for receiving an electron beam such that the electron beam and the received ions can interact in a region located at an intersection of said axial and said transverse channels,
a source for generating an electron beam,
an electrode positioned between said source and an inlet of said transverse channel for accelerating electrons of the electron beam to a desired kinetic energy,
a DC voltage source configured to apply a DC voltage to said electrode, and
a controller in communication with said DC voltage source for controlling the DC voltage applied to said electrode so as to adjust an energy of said electron beam between a first and a second energy regime, wherein in the first energy regime EID fragmentation of a plurality of precursor ions introduced into the branched RF ion trap can occur and in the second energy regime EID fragmentation is substantially inhibited.

11. The mass spectrometer of claim 10, further comprising an ion source for receiving a sample and ionizing said sample so as to generate said plurality of precursor ions.

12. The mass spectrometer of claim 10, further comprising an ion guide positioned downstream of said ion source for receiving at least a portion of said precursor ions and focusing said ions into an ion beam.

13. The mass spectrometer of claim 12, further comprising a first mass analyzer positioned downstream of the ion guide and upstream of said branched RF ion trap for receiving said ion beam, wherein said first mass analyzer is configured to select precursor ions having a target m/z ratio for transmission to said branched RF ion trap, wherein at least a portion of said precursor ions undergoes fragmentation in said branched RF ion trap to generate a plurality of product ions.

14. The mass spectrometer of claim 13, further comprising a second mass analyzer positioned downstream of said branched RF ion trap for receiving at least a portion of said plurality of product ions.

15. The mass spectrometer of claim 14, further comprising an ion detector positioned downstream of said second mass analyzer for receiving at least a portion of said product ions transmitted through said second mass analyzer and generating ion detection signals in response to detection of said product ions.

16. The mass spectrometer of claim 15, further comprising an analysis module in communication with said ion detector to receive said ion detection signals, wherein said analysis module is configured to process said ion detection signals to generate a mass spectrum of the product ions transmitted through said second mass analyzer.

17. The mass spectrometer of claim 16, wherein said analysis module is further configured to compare a mass spectrum of the sample generated with the electron kinetic energy within said first energy regime with a mass spectrum of the sample generated with the electron kinetic energy within said second energy regime to identify mass peaks corresponding to product ions generated via EID fragmentation.

18. The mass spectrometer of claim 10, wherein said first energy regime spans a range of about 10 eV to about 20 eV and said second energy regime spans a range of about 30 eV to about 50 eV.

19. The mass spectrometer of claim 17, wherein the spectral comparison is performed via spectrum subtraction resulting in subtracted spectra.

20. The mass spectrometer of claim 19, wherein the subtracted spectra is further matched to a library spectra.
